(19) United States
(12) Patent Application Publication
(10) Pub. No.: US 2007/0081674 A1
(43) Pub. Date: Apr. 12, 2007

(54) Method and apparatus of amplifying stereo effect

(75) Inventors: Oan-Jin Kim, Suwon-si (KR); Hyuch-Jae Lee, (US)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/503,206

(22) Filed: Aug. 14, 2006

(30) Foreign Application Priority Data
Oct. 7, 2005 (KR) 2005-94512

(51) Int. Cl. H04R 5/00

(52) U.S. Cl. 381/1; 381/17

(57) ABSTRACT

A method and apparatus of amplifying a stereo effect of a stereo sound recording apparatus, the apparatus including a first signal processing unit to amplify a separation degree of left sound and right sound through feed-forward cross-mixing of left and right channel input signals with a predetermined delay value, and a second signal processing unit to correct low frequency characteristics through feedback summation of the left and right channel signals processed in the first signal processing unit, with a predetermined delay value.

### CROSS-REFERENCE TO RELATED APPLICATIONS

This application claims priority under 35 U.S.C. §119(a) from Korean Patent Application No. 10-2005-0094512, filed on Oct. 7, 2005, in the Korean Intellectual Property Office, the disclosure of which is incorporated herein in its entirety by reference.

### BACKGROUND OF THE INVENTION

1. Field of the Invention

The present general inventive concept relates to a stereo sound recording system with two embedded microphones, and more particularly, to a method and apparatus of amplifying a stereo effect of a stereo sound recording system.

2. Description of the Related Art

Generally, when stereo sound is recorded in a device with a small embedded microphone, such as a camcorder, there is only a short distance between left and right microphones thereof and there is only a small difference between left and right channel signals thereof. Accordingly, an apparatus is used to amplify a stereo effect by amplifying a difference between left and right microphone outputs.

A conventional technology related to this stereo effect amplifying apparatus is disclosed in Japanese Patent Laid-Open Application 2001-189999 (filed on Dec. 28, 1999, in the Japanese Patent Office).

FIG. 1 is a view illustrating a block diagram of a conventional stereo effect amplification apparatus. Referring to FIG. 1, a first output signal 109 is fed back (i.e., in a direction from the first and second outputs towards the first and second inputs) to a first delay unit 105. The first delay unit 105 delays the first output 109 (of a first adder 103) for a predetermined time. A second output signal 110 is fed back to a second delay unit 106. The second delay unit 106 delays the second output 110 (of a second adder) 104 for a predetermined time. A first multiplier 107 multiplies an output of the first delay unit 105 by a predetermined value. A second multiplier 108 multiplies an output of the second delay unit 106 by a predetermined value. The first adder 103 generates the first output 109 by adding a first voice signal input 101 (for example, a left voice signal) of a stereo signal to an output of the second multiplier 108. The second adder 104 generates the second output 110 by adding a second voice signal input 102 (for example, a right voice signal) of a stereo signal to an output of the first multiplier 107.

Accordingly, a difference between the left voice signal and the fed-back second (right) output signal becomes a left output signal. Then, the left output signal is adjusted to have a size that is 93.75% of an original size of the original signal by being delayed for one sample time, and then is fed back to be subtracted from the right voice signal. In the same manner, a difference between the right voice signal and the fed back first (left) output signal becomes a right output signal. Then, the right output signal is adjusted to have a size that is 93.75% of an original size of the original signal by being delayed for one sample time, and then is fed back to be subtracted from the left voice signal.

FIG. 2 is a view illustrating a directivity pattern showing a frequency characteristic of a right output signal in relation to a sound source in each direction using the apparatus of FIG. 1.

A response to a right (90 degrees) sound source is greater than a response to a left (270 degrees) sound source. Accordingly, FIG. 2 illustrates that a stereo effect in the response to the right (90 degrees) sound source is emphasized more than that in the response to the left (270 degrees) sound source. However, since the responses to the left and right sound sources are much bigger (up to 4.2 times bigger) than a response to the front (0 degrees) sound source and an excessive sound field expansion phenomenon occurs, sound heard by listeners is unnatural. Also, an excessive emphasis of a stereo effect occurring in a low frequency band (equal to or lower than 1 kHz) causes amplification of an effect of wind sound.

### SUMMARY OF THE INVENTION

The present general inventive concept provides a method and apparatus of amplifying a stereo effect, by which a signal difference of left and right channel signals in a frequency band equal to or higher than 1 kHz of an input signal is amplified, and a magnitude difference of signals of front and side sound sources is reduced. By smoothing the frequency response of the front sound source, stereo feeling is amplified without distorting sound quality, and by removing a directivity characteristic in a low frequency band, an effect of wind sound is minimized.

The present general inventive concept also provides a stereo sound recording system to which the method and apparatus of amplifying a stereo effect are applied.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to amplify a stereo effect, including a first signal processing unit to amplify a left and right separation degree of a stereo channel input signal by feed-forward cross mixing a first stereo channel input signal with the delayed stereo channel input signal, and a second signal processing unit to correct low frequency characteristics of the stereo channel input signal processed in the first signal processing unit by feedback-cross mixing of the stereo channel input signal processed in the first signal processing unit with a second delayed stereo channel signal.

The first signal processing unit may include a first delay unit to delay a left microphone signal according to a first predetermined delay value, a first multiplier to adjust a magnitude of the output of the first delay unit according to a first predetermined multiplication value, a first adder to subtract an output signal of the first multiplier from a right microphone signal, a second delay unit to delay the right microphone signal according to a second predetermined delay value, a second multiplier to adjust an output value of the second delay unit according to a second predetermined multiplication value, and a second adder to subtract an output signal of the second multiplication unit from the left microphone signal.

The second signal processing unit may include a third delay unit and a fourth delay unit to delay outputs of the first and second adders, respectively, according to third and fourth predetermined delay values, respectively, a third multiplier and a fourth multiplier to adjust magnitudes of output signals of the third and fourth delay units, respectively, according to third and fourth predetermined multiplication values, respectively, and a third adder and a fourth adder to add output signals of the third and fourth multipliers, respectively, to the output signals of the first and second adders, respectively.

The foregoing and/or other aspects and utilities of the present general inventive concept may also be achieved by providing a method of amplifying a stereo effect in a stereo sound recording apparatus, the method including performing a first signal processing process, including delaying a first side microphone signal of a stereo channel according to a first predetermined delay value, adjusting a magnitude of the delayed first side microphone signal according to a first predetermined multiplication value, subtracting the adjusted first side microphone signal from a second side microphone signal of the stereo channel to generate a first output signal, delaying the second side microphone signal of the stereo channel according to a second predetermined delay, adjusting a value of the delayed second side microphone signal according to a second predetermined multiplication value, and subtracting the adjusted second side microphone signal from the first side microphone signal of the stereo channel to generate a second output signal, and performing a second signal processing process, including delaying the first and second output signals according to third and fourth predetermined delay values, respectively, adjusting the magnitudes of the delayed first and second output signals according to third and fourth predetermined multiplication values, respectively, and adding the adjusted first and second side microphone signals to the first and second output signals, respectively.

The foregoing and/or other aspects and utilities of the present general inventive concept may also be achieved by providing an apparatus to amplify a stereo effect of first and second channel audio signals, including a first signal processing unit to improve a separation degree of the first and second channel audio signals by applying the first and second channel audio signals to a feed-forward cross-mixing process using first predetermined delay and multiplication values to generate first and second processed audio signals, and a second signal processing unit to correct a low frequency distortion characteristic of the first and second processed audio signals by applying the first and second processed audio signals to a feedback summation process using second predetermined delay and multiplication values to generate an amplified stereo effect of the first and second channel audio signals.

The amplified stereo effect of the first and second channel audio signals may have substantially no directivity in a frequency band equal to or less than 1 kHz. The amplified stereo effect of the first and second channel audio signals may occur between 1 kHz and 10 kHz.

The first signal processing unit may subtract a delayed and multiplied signal of the first channel audio signal from the second channel audio signal to generate the first processed audio signal, and may subtract a delayed and multiplied signal of the second channel audio signal from the first channel audio signal to generate the second processed audio signal. The first signal processing unit may include a first feed-forward cross-mixing circuit to subtract a delayed and multiplied signal of the first channel audio signal from the second channel audio signal to generate the first processed audio signal, and a second feed-forward cross-mixing circuit to subtract a delayed and multiplied signal of the second channel audio signal from the first channel audio signal to generate the second processed audio signal.

The first feed-forward cross-mixing circuit may include a first delay unit to delay the first channel audio signal fed forward to the first delay unit from a first signal input using the first delay value to generate a first delayed signal, a first multiplier downstream of the first delay unit to multiply the first delayed signal by the first multiplication value to generate a first multiplied signal, and a first combining unit downstream of the first multiplier to subtract the first multiplied signal from the second channel audio signal to generate the first processed audio signal, and the second feed-forward cross-mixing circuit may include a second delay unit to delay the second channel audio signal fed forward to the second delay unit from a second signal input using the first delay value to generate a second delayed signal, a second multiplier downstream of the second delay unit to multiply the second delayed signal by the first multiplication value to generate a second multiplied signal, and a second combining unit downstream of the second multiplier to subtract the second multiplied signal from the first channel audio signal to generate the second processed audio signal.

The second signal processing unit may add a delayed and multiplied signal of the first processed audio signal to the first processed audio signal to generate a first output audio signal, and may add a delayed and multiplied signal of the second processed audio signal to the second processed audio signal to generate a second output audio signal. The second signal processing unit may include a first feedback summation circuit to add a delayed and multiplied signal of the first processed audio signal to the first processed audio signal to generate the first output audio signal, and a second feedback summation circuit to add a delayed and multiplied signal of the second processed audio signal to the second processed audio signal to generate the second output audio signal.

The first feedback summation circuit may include a third delay unit to delay the first processed audio signal fed backwards to the third delay unit using the second delay value to generate a third delayed signal, a third multiplier upstream of the third delay unit to multiply the third delayed signal by the second multiplication value to generate a third multiplied signal, and a third combining unit upstream of the third multiplier to add the third multiplied signal to the first processed audio signal to generate the first output audio signal, and the second feedback summation circuit may include a fourth delay unit to delay the second processed audio signal fed backwards to the fourth delay unit using the second delay value to generate a fourth delayed signal, a fourth multiplier upstream of the fourth delay unit to multiply the fourth delayed signal by the second multiplication value to generate a fourth multiplied signal, and a fourth combining unit upstream of the fourth multiplier to add the fourth multiplied signal to the second processed audio signal to generate the second output audio signal.

The foregoing and/or other aspects and utilities of the present general inventive concept may also be achieved by providing a method of amplifying a stereo effect amplification of first and second channel audio signals, including performing a feed-forward cross-mixing process on the first and second channel audio signals based on first predetermined delay and multiplication values to generate first and second processed audio signals, and performing a feedback summation process on the first and second processed audio signals based on second predetermined delay and multiplication values to generate the amplified stereo effect of the first and second channel audio signals.

The performing of the feed-forward cross-mixing process may include subtracting a delayed and multiplied signal of the first channel audio signal from the second channel audio signal to generate the first processed audio signal, and subtracting a delayed and multiplied signal of the second channel audio signal from the first channel audio signal to generate the second processed audio signal. The performing of the feedback summation process may include adding a delayed and multiplied signal of the first processed audio signal to the first processed audio signal to generate a first output audio signal, and adding a delayed and multiplied signal of the second processed audio signal to the second processed audio signal to generate a second output audio signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a block diagram of a conventional stereo effect amplification apparatus;

FIG. 2 is a view illustrating a directivity pattern showing a frequency characteristic of a right output signal in relation to a sound source in each direction using the apparatus of FIG. 1;

FIG. 3 is a view illustrating a block diagram of an entire stereo sound recording system to which a method of amplifying a stereo effect, according to an embodiment of the present general inventive concept, is applied;

FIG. 4 is a view illustrating a detailed block diagram of an apparatus to amplify a stereo effect, according to an embodiment of the present general inventive concept;

FIG. 5 is a view illustrating a frequency characteristic of an apparatus to amplify a stereo effect, according to an embodiment of the present general inventive concept;

FIG. 6 is a view illustrating frequency characteristics of left and right output signals in relation to a right sound source, according to conventional technology; and

FIG. 7 is a view illustrating frequency characteristics of left and right output signals in relation to a right sound source, according to an embodiment of the present general inventive concept.

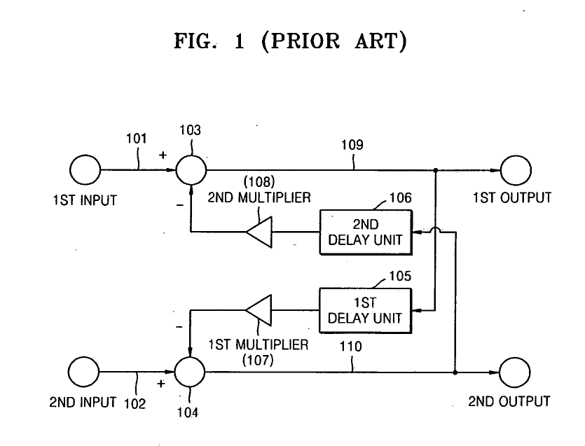

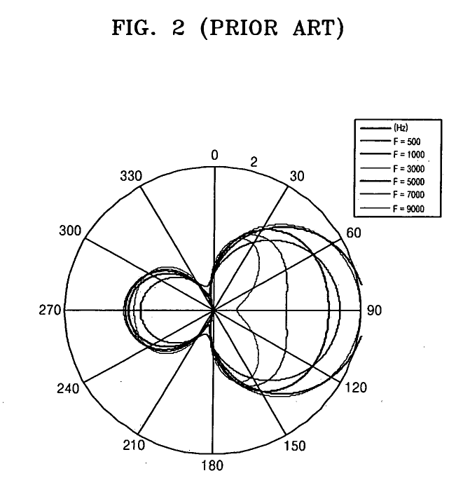

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

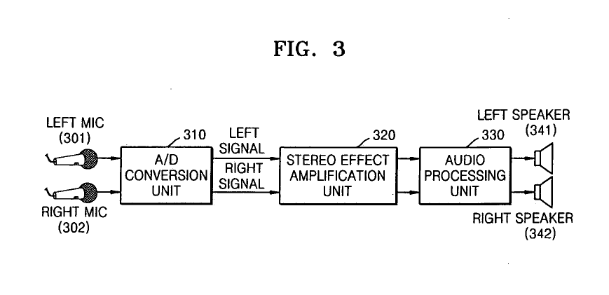

FIG. 3 is a view illustrating a block diagram of an entire stereo sound recording system to which a method of amplifying a stereo effect, according to an embodiment of the present general inventive concept, is applied.

The stereo sound recording system of FIG. 3 includes an analog to digital conversion unit 310, a stereo effect amplification unit 320, and an audio processing unit 330.

The A/D conversion unit 310 converts left and right channel analog audio signals output from a left microphone 301 and a right microphone 302, respectively, into left and right channel digital audio signals.

The stereo effect amplification unit 320 amplifies a stereo effect of the left and right channel audio signals output from the A/D conversion unit 310 using a combination of feed-forward cross-mixing and feedback summation having a multiplication value and a delay value.

The audio processing unit 330 performs post-processing of the left and right channel audio signals, such as dubbing, mixing and level adjusting.

Left and right speakers 341 and 342 reproduce the audio signals that are post-processed in the audio processing unit 330.

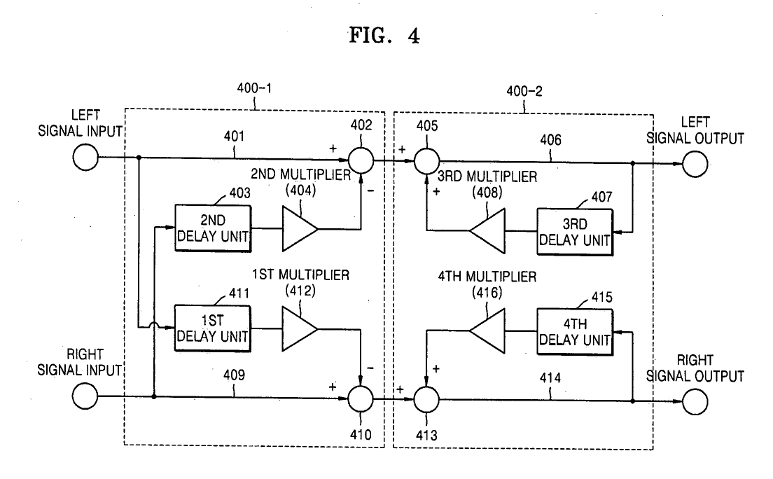

FIG. 4 is a view illustrating a detailed block diagram of an apparatus to amplify a stereo effect, according to an embodiment of the present general inventive concept.

The stereo effect amplifying apparatus of FIG. 4 includes a first signal processing unit 400-1 to improve a left and right separation degree using a feed-forward cross-mixing structure, and a second signal processing unit 400-2 to correct a low frequency characteristic using a feedback summation structure.

Referring to FIG. 4, the stereo effect amplifying apparatus will now be explained in more detail.

An audio signal 401 output from a left microphone and input into the stereo effect amplifying apparatus is fed forward (i.e., in a direction from the left and right signal inputs towards the left and right signal outputs) to a first delay unit 411. The first delay unit 411 delays the audio signal 401 input through a left microphone according to a predetermined delay value.

A first multiplier 412 adjusts a level of the audio signal delayed in the first delay unit 411, according to a predetermined multiplication value.

A first adder 410 subtracts the audio signal output from the first multiplier 412 from an audio signal 409 output from a right microphone and input into the stereo effect amplifying apparatus.

The audio signal 409 output from the right microphone and input into the stereo effect amplifying apparatus is also fed forward to a second delay unit 403. The second delay unit 403 delays the audio signal 409 input through the right microphone according to a predetermined delay value.

A second multiplier 404 adjusts a level of the audio signal output from the second delay unit 403, according to a predetermined multiplication value.

A second adder 402 subtracts the audio signal output from the second multiplier 404 from the audio signal 401 output from the left microphone and not fed forward to the first delay unit 411.

Accordingly, by subtracting a signal of one audio channel (e.g., a left audio channel signal) having a delayed and multiplied value from another audio channel signal (e.g., a right audio channel signal), the first signal processing unit 400-1 amplifies sound pressures close to the left and right microphones, respectively, and reduces sound pressures distant from the left and right microphones, respectively. By doing so, left and right separation degree can be enhanced.

An output audio signal 406 of the left channel is fed back (i.e., in a direction from the left and right signal outputs towards the left and right signal inputs) to a third delay unit 407. The third delay unit 407 delays the output audio signal 406 of the left channel according to a predetermined delay value.

A third multiplier 408 adjusts a level of the audio signal output from the third delay unit 407 according to a predetermined multiplication value.

A third adder 405 adds the audio signal output from the third multiplier 408 and the audio signal output from the second adder 402.

An output audio signal 414 of the right channel is fed back to a fourth delay unit 415. The fourth delay unit 415 delays the output audio signal 414 of the right channel according to a predetermined delay value.

A fourth multiplier 416 adjusts a level of the audio signal output from the fourth delay unit 415 according to a predetermined multiplication value.

A fourth adder 413 adds the audio signal output from the fourth multiplier 416 and the audio signal output from the first adder 410.

Accordingly, by adding the output signal of the first signal processing unit 400-1 to the delayed and multiplied feedback signal through a feed-forward cross-mixing structure, the second signal processing unit 400-2 corrects a low frequency distortion.

Referring again to FIG. 4, when an operation frequency of the first, second, third, and fourth delay units 411, 403, 407, and 415 is 32 kHz, the delays have a delay of one sample time, and when the operation frequency thereof is 48 kHz, the delays have a delay of two sample times. Coefficients of the first, second, third, and fourth multipliers 412, 404, 408, and 416 may be set to 0.6. The delay values of the first, second, third, and fourth delay units 411, 403, 407, and 415 may be set to an identical value so that a frequency characteristic at a front sound source of a listener becomes uniform. Likewise, the coefficients of the first, second, third, and fourth multipliers 412, 404, 408, and 416 may be set to an identical value so that the frequency characteristic of the front sound source can be uniform.

The outputs of the first and second adders 410 and 402 amplify the microphone signals collected from the sound sources positioned at the left and right sides, respectively. The third adder 405 adds the output of the second adder 402 to the output of the third multiplier 408, which is obtained by a feed back mechanism, thereby delaying and reducing the output of the third adder 405. The fourth adder 413 adds the output of the first adder 410 to the output of the fourth multiplier 416, which is obtained by a feed back mechanism, thereby delaying and reducing the output of fourth adder 413.

This feedback summation structure having a multiplication value and a delay value is similar to applying an infinite impulse response (IIR) filter to the output signals of the first and second adders 410 and 402. The IIR filter has an effect of amplifying a low frequency component attenuated in the output signals of the first and second adders 410 and 402, and preventing the frequency characteristic of the front sound source from being distorted.

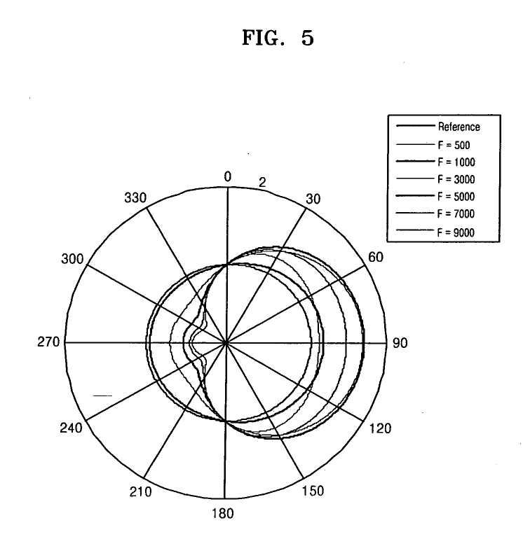

FIG. 5 is a view illustrating a directivity pattern, according to an embodiment of the present general inventive concept, illustrating a frequency characteristic of a right output signal in relation to sound sources in all directions.

Referring to FIG. 5, a gain difference of front and right sound sources is greatly improved compared to that of a conventional method (maximum 1.6 times), and in the front sound source, the gains for all frequencies are uniform. Also, FIG. 5 illustrates that there is almost no directivity in a frequency band equal to or lower than 1 kHz.

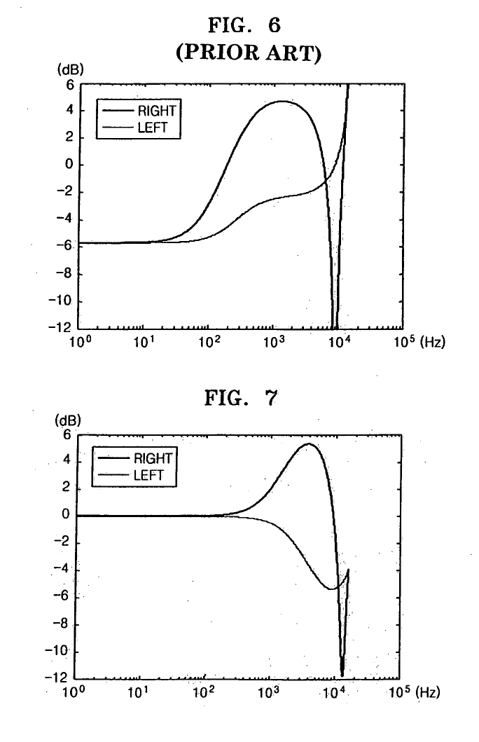

FIG. 6 is a view illustrating a comparison of frequency characteristics of left and right output signals in relation to a right sound source, according to conventional technology, and FIG. 7 is a view illustrating a comparison of frequency characteristics of left and right output signals in relation to a right sound source, according to an embodiment of the present general inventive concept. In FIGS. 6 and 7, the x coordinate indicates frequency (f) and the y coordinate indicates gain (dB). FIG. 7 illustrates that there is no attenuation in a low frequency band (equal to or lower than 1 kHa), and that a stereo effect occurs between 1 kHz and 10 kHz, according to this embodiment of the present general inventive concept. In contrast, FIG. 6 illustrates that there is great attenuation in the low frequency band, and that a stereo effect occurs between 100 Hz and 10 kHz, according to conventional technology, causing a problem in that wind sound formed with a low frequency is amplified.

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present general inventive concept as described above, a signal difference between left and right channel signals in a frequency band equal to or higher than 1 kHz of an input signal can be amplified and a magnitude difference of signals of front and side sound sources can be reduced. In particular, by smoothing a frequency response of the front sound source, a stereo effect can be amplified without distorting sound quality. Furthermore, by removing a directivity characteristic in a low frequency band, an effect of wind sound can be minimized.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to amplify a stereo effect, comprising:
a first signal processing unit to amplify a left and right separation degree of a stereo channel input signal by feed-forward cross mixing the stereo channel input signal with a first delayed stereo channel input signal; and
a second signal processing unit to correct low frequency characteristics of the stereo channel input signal processed in the first signal processing unit by feedback-cross mixing the stereo channel input signal processed in the first signal processing unit with a second delayed stereo channel signal.

2. The apparatus of claim 1, wherein the first signal processing unit comprises:
a first delay unit to delay a left microphone signal according to a first predetermined delay value;
a first multiplier to adjust a magnitude of an output of the first delay unit according to a first predetermined multiplication value;
a first adder to subtract an output signal of the first multiplier from a right microphone signal;
a second delay unit to delay the right microphone signal according to a second predetermined delay value;
a second multiplier to adjust an output value of the second delay unit according to a second predetermined multiplication value; and
a second adder to subtract an output signal of the second multiplication unit from the left microphone signal.

3. The apparatus of claim 1, wherein the second signal processing unit comprises:
a third delay unit and a fourth delay unit to delay outputs of the first and second adders, respectively, according to third and fourth predetermined delay values, respectively;
a third multiplier and a fourth multiplier to adjust magnitudes of output signals of the third and fourth delay units, respectively, according to third and fourth predetermined multiplication values, respectively; and
a third adder and a fourth adder to add output signals of the third and fourth multipliers, respectively, to the output signals of the first and second adders, respectively.

4. The apparatus of claim 3, wherein the first, second, third, and fourth predetermined delay values are the same.

5. The apparatus of claim 3, wherein the first, second, third, and fourth predetermined multiplication values are the same.

6. The apparatus of claim 1, wherein the apparatus implements a stereo effect in a frequency band from 1 kHz to 100 kHz.

7. A method of amplifying a stereo effect in a stereo sound recording apparatus, the method comprising:
performing a first signal processing process, comprising:
delaying a first side microphone signal of a stereo channel according to a first predetermined delay value,
adjusting a magnitude of the delayed first side microphone signal according to a first predetermined multiplication value,
subtracting the adjusted first side microphone signal from a second side microphone signal of the stereo channel to generate a first output signal,
delaying the second side microphone signal of the stereo channel according to a second predetermined delay,
adjusting a value of the delayed second side microphone signal according to a second predetermined multiplication value, and
subtracting the adjusted second side microphone signal from the first side microphone signal of the stereo channel to generate a second output signal; and
performing a second signal processing process, comprising:
delaying the first and second output signals according to third and fourth predetermined delay values, respectively,
adjusting the magnitudes of the delayed first and second output signals according to third and fourth predetermined multiplication values, respectively, and
adding the adjusted first and second side microphone signals to the first and second output signals, respectively.

8. The apparatus of claim 7, wherein the first, second, third, and fourth multiplication values are the same, and the first, second, third, and fourth delay values are the same, such that a frequency characteristic at a front sound source of a listener is uniform.

9. A stereo sound recording system, comprising:
an analog/digital conversion unit to convert left and right channel analog audio signals output from a left microphone and a right microphone, respectively, into digital audio signals;
a stereo effect amplification unit to amplify a stereo effect of the left and right channel audio signals input from the analog/digital conversion unit using a combination of a feed-forward cross-mixing and feedback-summation unit having at least one predetermined multiplication value and predetermined delay value; and
an audio signal processing unit to post-process the left and right channel audio signals in which the stereo effect is amplified in the stereo effect amplification unit.

10. An apparatus to amplify a stereo effect of first and second channel audio signals, comprising:
a first signal processing unit to improve a separation degree of the first and second channel audio signals by applying the first and second channel audio signals to a feed-forward cross-mixing process using first predetermined delay and multiplication values to generate first and second processed audio signals; and
a second signal processing unit to correct a low frequency distortion characteristic of the first and second processed audio signals by applying the first and second processed audio signals to a feedback summation process using second predetermined delay and multiplication values to generate an amplified stereo effect of the first and second channel audio signals.

11. The apparatus of claim 10, wherein the amplified stereo effect of the first and second channel audio signals has substantially no directivity in a frequency band equal to or less than 1 kHz.

12. The apparatus of claim 10, wherein the amplified stereo effect of the first and second channel audio signals occurs between 1 kHz and 10 kHz.

13. The apparatus of claim 10, wherein the first signal processing unit subtracts a delayed and multiplied signal of the first channel audio signal from the second channel audio signal to generate the first processed audio signal, and subtracts a delayed and multiplied signal of the second channel audio signal from the first channel audio signal to generate the second processed audio signal.

14. The apparatus of claim 13, wherein the first signal processing unit comprises:
a first feed-forward cross-mixing circuit to subtract a delayed and multiplied signal of the first channel audio signal from the second channel audio signal to generate the first processed audio signal; and
a second feed-forward cross-mixing circuit to subtract a delayed and multiplied signal of the second channel audio signal from the first channel audio signal to generate the second processed audio signal.

15. The apparatus of claim 14, wherein:
the first feed-forward cross-mixing circuit comprises:
a first delay unit to delay the first channel audio signal fed forward to the first delay unit from a first signal input using the first delay value to generate a first delayed signal,
a first multiplier downstream of the first delay unit to multiply the first delayed signal by the first multiplication value to generate a first multiplied signal, and
a first combining unit downstream of the first multiplier to subtract the first multiplied signal from the second channel audio signal to generate the first processed audio signal; and
the second feed-forward cross-mixing circuit comprises:
a second delay unit to delay the second channel audio signal fed forward to the second delay unit from a second signal input using the first delay value to generate a second delayed signal,
a second multiplier downstream of the second delay unit to multiply the second delayed signal by the first multiplication value to generate a second multiplied signal, and
a second combining unit downstream of the second multiplier to subtract the second multiplied signal from the first channel audio signal to generate the second processed audio signal.

16. The apparatus of claim 10, wherein the second signal processing unit adds a delayed and multiplied signal of the first processed audio signal to the first processed audio signal to generate a first output audio signal, and adds a delayed and multiplied signal of the second processed audio signal to the second processed audio signal to generate a second output audio signal.

17. The apparatus of claim 16, wherein the second signal processing unit comprises:
a first feedback summation circuit to add a delayed and multiplied signal of the first processed audio signal to the first processed audio signal to generate the first output audio signal; and
a second feedback summation circuit to add a delayed and multiplied signal of the second processed audio signal to the second processed audio signal to generate the second output audio signal.

18. The apparatus of claim 17, wherein:
the first feedback summation circuit comprises:
a third delay unit to delay the first processed audio signal fed backwards to the third delay unit using the second delay value to generate a third delayed signal,
a third multiplier upstream of the third delay unit to multiply the third delayed signal by the second multiplication value to generate a third multiplied signal, and
a third combining unit upstream of the third multiplier to add the third multiplied signal to the first processed audio signal to generate the first output audio signal; and
the second feedback summation circuit comprises:
a fourth delay unit to delay the second processed audio signal fed backwards to the fourth delay unit using the second delay value to generate a fourth delayed signal,
a fourth multiplier upstream of the fourth delay unit to multiply the fourth delayed signal by the second multiplication value to generate a fourth multiplied signal, and
a fourth combining unit upstream of the fourth multiplier to add the fourth multiplied signal to the second processed audio signal to generate the second output audio signal.

19. A method of amplifying a stereo effect amplification of first and second channel audio signals, comprising:
performing a feed-forward cross-mixing process on the first and second channel audio signals based on first predetermined delay and multiplication values to generate first and second processed audio signals; and
performing a feedback summation process on the first and second processed audio signals based on second predetermined delay and multiplication values to generate the amplified stereo effect of the first and second channel audio signals.

20. The method of claim 19, wherein the performing of the feed-forward cross-mixing process comprises:
subtracting a delayed and multiplied signal of the first channel audio signal from the second channel audio signal to generate the first processed audio signal; and
subtracting a delayed and multiplied signal of the second channel audio signal from the first channel audio signal to generate the second processed audio signal.

21. The method of claim 19, wherein the performing of the feedback summation process comprises:
adding a delayed and multiplied signal of the first processed audio signal to the first processed audio signal to generate a first output audio signal; and
adding a delayed and multiplied signal of the second processed audio signal to the second processed audio signal to generate a second output audio signal.
